(19) United States
(12) Patent Application Publication
(10) Pub. No.: US 2026/0254082 A1
(43) Pub. Date: Aug. 27, 2026

(54) RESONATOR AND FILTER CIRCUIT

(71) Applicant: Kabushiki Kaisha Toshiba, Kawasaki-shi (JP)

(72) Inventors: Tamio KAWAGUCHI, Yokohama Kanagawa (JP); Hiroaki IKEUCHI, Yokohama Kanagawa (JP)

(21) Appl. No.: 19/449,146

(22) Filed: Jan. 14, 2026

(30) Foreign Application Priority Data
Feb. 26, 2025 (JP) 2025-028960

(51) Int. Cl. H01P 1/20; H01P 7/00

(52) U.S. Cl. CPC H01P 1/20; H01P 7/00

(57) ABSTRACT

According to one embodiment, a resonator includes a structure, and a metal housing. The structure includes first and second conductive films, a dielectric substrate, a connecting member, and a capacitive member. The first conductive film includes a first extending region extending along a first direction and a first opposing region. A second direction from the first conductive film to the second conductive film crosses the first direction. The dielectric substrate is between the first and second conductive films. The connecting member pierces the dielectric substrate and electrically connects the first and second conductive films. The capacitive member is between the first extending region and the first opposing region. The metal housing includes first and second metal portions and a side portion. The structure is between the first and second metal portions in the first direction. The side portion is around the structure in a plane crossing the first direction.

### CROSS-REFERENCE TO RELATED APPLICATIONS

This application is based upon and claims the benefit of priority from Japanese Patent Application No. 2025-028960, filed on February 26, 2025; the entire contents of which are incorporated herein by reference.

### FIELD

Embodiments described herein relate generally to a resonator and a filter circuit.

### BACKGROUND

For example, in high-frequency circuits, resonators are used in filter circuits. There is a demand for improved characteristics in the resonators and filter circuits.

### BRIEF DESCRIPTION OF THE DRAWINGS

FIGS. 1A to 1C are schematic views illustrating a resonator according to a first embodiment;

FIGS. 2A and 2B are schematic diagrams illustrating a resonator of a reference example;

FIGS. 3A to 3C are schematic views illustrating a resonator according to the first embodiment;

FIGS. 4A to 4C are schematic views illustrating a filter circuit according to a second embodiment;

FIGS. 5A and 5B are schematic diagrams illustrating the characteristics of the filter circuit according to the second embodiment;

FIG. 6 is a schematic view illustrating a filter circuit according to a third embodiment;

FIGS. 7A and 7B are schematic views illustrating the filter circuit according to the third embodiment;

FIGS. 8A and 8B are schematic plan views illustrating a resonator according to a fourth embodiment;

FIG. 9 is a graph illustrating the characteristics of the resonator; and

FIG. 10 is a graph illustrating the characteristics of the resonator.

### DETAILED DESCRIPTION

According to one embodiment, a resonator includes a structure, and a metal housing. The structure includes a first conductive film, a second conductive film, a dielectric substrate, a connecting member, and a capacitive member. The first conductive film includes a first extending region extending along a first direction and a first opposing region. A second direction from the first conductive film to the second conductive film crosses the first direction. The dielectric substrate is between the first conductive film and the second conductive film. The connecting member pierces the dielectric substrate and electrically connects the first conductive film and the second conductive film. The capacitive member is between the first extending region and the first opposing region. The metal housing includes a first metal portion, a second metal portion, and a side portion. The structure is between the first metal portion and the second metal portion in the first direction. The side portion is around the structure in a plane crossing the first direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

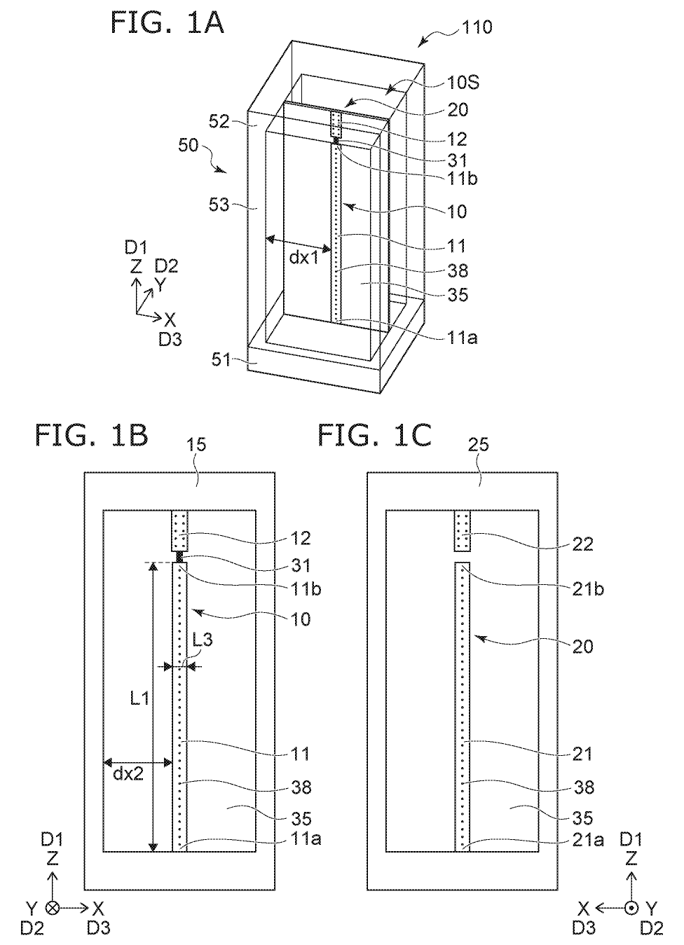

FIGS. 1A to 1C are schematic views illustrating a resonator according to a first embodiment.

FIG. 1A is a see-through perspective view. FIGS. 1B and 1C are plan views.

As shown in FIG. 1A, a resonator 110 according to an embodiment includes a structure 10S and a metal housing 50.

The structure 10S includes a first conductive film 10, a second conductive film 20, a dielectric substrate 35, a connecting member 38, and a capacitive member 31.

The first conductive film 10 includes a first extending region 11 and a first opposing region 12. The first extending region 11 extends along a first direction D1.

The first direction D1 is defined as a Z-axis direction. A direction perpendicular to the Z-axis direction is defined as a Y-axis direction. A direction perpendicular to the Z-axis direction and the X-axis direction is defined as an X-axis direction.

A second direction D2 from the first conductive film 10 to the second conductive film 20 crosses the first direction D1. The second direction D2 may be, for example, the Y-axis direction.

The dielectric substrate 35 is between the first conductive film 10 and the second conductive film 20. The connecting member 38 pierces the dielectric substrate 35 and electrically connects the first conductive film 10 and the second conductive film 20 to each other. In this example, a plurality of connecting members 38 are provided. The plurality of connecting members 38 pierce the dielectric substrate 35 and electrically connect the first conductive film 10 and the second conductive film 20 to each other.

The capacitive member 31 is between the first extending region 11 and the first opposing region 12. In this example, the first extending region 11 includes a first portion 11a and a first other portion 11b. A direction from the first portion 11a to the first other portion 11b is along the first direction D1. The capacitive member 31 is between the first other portion 11b and the first opposing region 12.

The metal housing 50 includes a first metal portion 51, a second metal portion 52, and a side portion 53. The structure 10S is between the first metal portion 51 and the second metal portion 52 in the first direction D1. The side portion 53 is around the structure 10S in a plane (e.g., the X-Y plane) that crosses the first direction D1.

In the embodiment, the first extending region 11 of the first conductive film 10 extends along the first direction D1. The first extending region 11 functions, for example, as at least a part of a central conductive member of a coaxial resonator. The metal housing 50 functions as an outer ground conductive member of the coaxial resonator.

In the embodiment, the first extending region 11 is stably supported by the dielectric substrate 35. The first extending region 11 being thin is stably obtained. In the embodiment, for example, a high Q value is stably obtained. A resonator capable of improving characteristics is provided.

For example, the capacitance of the capacitive member 31 may be variable. The resonant frequency can be controlled by changing the capacitance of the capacitive member 31. In the embodiment, a high Q value can be obtained even in a wide range of variable frequencies. For example, loss can be suppressed.

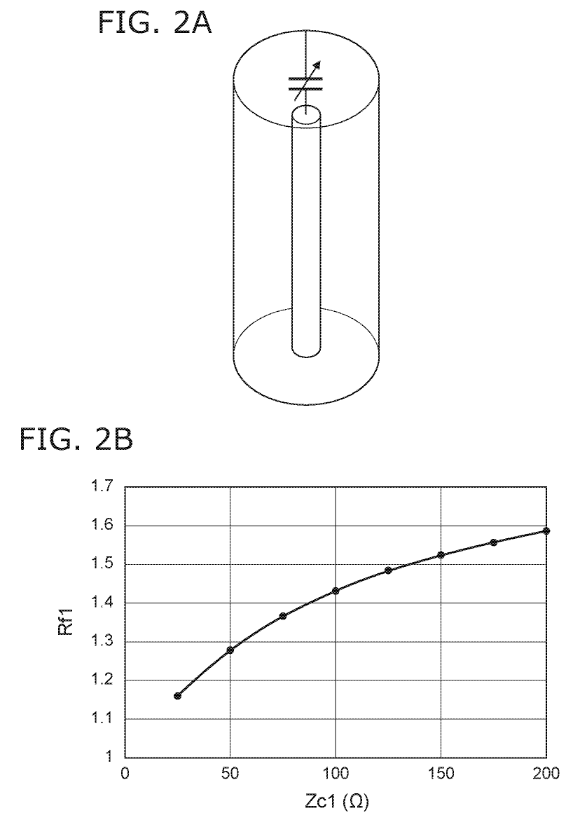

FIGS. 2A and 2B are schematic diagrams illustrating a resonator of a reference example.

As shown in FIG. 2A, a resonator of the reference example has a semi-coaxial structure. The resonator of the reference example includes a central conductive member and an outer conductive member surrounding it. The characteristic impedance Zc1 of the resonator can be calculated from the outer diameter of the central conductive member and the inner diameter of the outer conductive member. In this example, there is an air gap between the inner conductive member and the outer conductive member. One end of the central conductive member is grounded, and the other end is open. Such a resonator functions as a 1/4 wavelength coaxial resonator. A variable capacitance diode is connected to the other end of the central conductive member. The frequency can be adjusted by the capacitance of the variable capacitance diode. The variable capacitance diode may be, for example, a varactor diode.

FIG. 2B shows an example of the calculation results of the change in the resonant frequency fluctuation Rf1 when the capacitance of the variable capacitance diode is changed for each of the cases where the characteristic impedance of such a resonator is changed. The fluctuation Rf1 is a ratio of the highest value to the lowest value in the range of variable resonant frequencies.

As shown in FIG. 2B, as the characteristic impedance Zc1 increases, the frequency fluctuation Rf1 increases. To obtain a large tuning range, it is preferable to increase not only the variable value of the capacitance but also the characteristic impedance Zc1 of the coaxial structure connected to it.

Generally, the characteristic impedance of a coaxial structure is a function of the ratio of the inner diameter of the outer conductive member to the outer diameter of the inner conductive member. For example, a high characteristic impedance Zc1 can be obtained by narrowing the inner conductive member or by enlarging the inner diameter of the outer conductive member. For example, by narrowing the inner conductive member, a high characteristic impedance Zc1 can be obtained while keeping the overall size small.

In the embodiment, the first extending region 11 extending in the first direction D1 is provided. The first extending region 11 can be stably formed in a thin shape on the dielectric substrate 35. This allows a high characteristic impedance Zc1 to be stably obtained while maintaining a small size. The range of variable resonant frequencies can be increased while maintaining a high Q value.

In the embodiment, the metal housing 50 may be set to a fixed potential (e.g., ground potential). As shown in FIG. 1A, the first portion 11a of the first extending region 11 may be electrically connected to the first metal portion 51 of the metal housing 50.

As shown in FIG. 1B, the first conductive film 10 may further include a first other region 15. The first other region 15 is located around the first extending region 11 in a first plane (Z-X plane) crossing the second direction D2. The first opposing region 12 may be connected to the first other region 15. In FIG. 1A, the first other region 15 is omitted.

As shown in FIG. 1C, the second conductive film 20 may include a second extending region 21 and a second other region 25. The second extending region 21 extends along the first direction D1. The direction from the first extending region 11 to the second extending region 21 is along the second direction D2. The second other region 25 is located around the second extending region 21 in the first plane (Z-X plane).

The second extending region 21 may include a second portion 21a and a second other portion 21b. The second portion 21a may be connected to the second other region 25. The second conductive film 20 may further include a second opposing region 22. The second opposing region 22 is connected to the second other region 25. The second opposing region 22 faces the second other portion 21b. The second opposing region 22 is separated from the second other portion 21b.

The connecting member 38 electrically connects the first extending region 11 and the second extending region 21. The first extending region 11, the second extending region 21, and the connecting member connecting them may function as an inner conductive member of the coaxial structure.

As shown in FIG. 1B, a length of the first extending region 11 along the first direction D1 is defined as a first length L1. A length (width) of the first extending region 11 along a third direction D3 is defined as a third length L3. The third direction D3 crosses a plane including the first direction D1 and the second direction D2. The third direction D3 may be, for example, the X-axis direction. In the embodiment, the first length L1 is 5 times or more the third length L3. A high characteristic impedance Zc1 is easily obtained. The first length L1 may be 10 times or more the third length L3. The first length L1 may be 50 times or more greater than the third length L3.

As shown in FIG. 1A, a distance between the first extending region 11 and the side portion 53 is defined as a first distance dx1. For example, the first length L1 of the first extending region 11 along the first direction D1 may be 1.5 times or more the first distance dx1. A high characteristic impedance Zc1 is easily obtained.

As shown in FIG. 1B, a distance between the first extending region 11 and the first other region 15 in the third direction D3 is defined as a second distance dx2. The first length L1 may be 1.5 times or more the second distance dx2. A high characteristic impedance Zc1 is easily obtained.

The first length L1 may be 10 times or more a thickness of the first conductive film 10 (and the first extending region 11). The thickness corresponds to the dimension along the second direction D2. The thickness of the first conductive film 10 (and the first extending region 11) may be, for example, not less than 0.1 μm and not more than 2000 μm.

In the embodiment, the characteristic impedance of the coaxial circuit including the first conductive film 10, the second conductive film 20, and the metal housing 50 is, for example, 100 Ω or more. For example, a large frequency variable range (frequency fluctuation amount Rf1) of 1.4 times or more can be obtained.

In the embodiment, the dielectric substrate 35 may include an insulating member. The insulating member may include at least one of an inorganic material or an organic material. The dielectric substrate 35 may include, for example, a material used in a flexible substrate. The material used in the flexible substrate may include, for example, a polyimide or liquid crystal polymer material. The dielectric substrate 35 may include, for example, a glass cloth substrate or a fluororesin-based substrate. The dielectric substrate 35 may include, for example, a ceramic substrate. The ceramic substrate may include, for example, alumina.

In the embodiment, at least one of the first conductive film 10, the second conductive film 20, the connecting member 38, or the metal housing 50 includes a metal. The metal includes, for example, at least one selected from the group consisting of gold and copper. The metal may include, for example, at least one of aluminum, an alloy containing aluminum, niobium, an alloy such as niobium titanium, tantalum, or an alloy containing tantalum. At least one of the first conductive film 10, the second conductive film 20, the connecting member 38, or the metal housing 50 may include a material that exhibits superconducting properties at low temperatures.

The capacitive member 31 may include at least one selected from the group consisting of a capacitor, a variable capacitance diode, a MEMS capacitor, and a variable capacitor. The capacitive member 31 may include an electromagnetic field coupling structure including a plurality of electrodes.

The space between the metal housing 50 and the dielectric substrate 35 may include, for example, air, an inert gas, or an insulating gas. The space between the metal housing 50 and the dielectric substrate 35 may be, for example, reduced pressure.

The structure 10S is sandwiched between plurality of portions of the metal housing 50. A coaxial structure can be easily obtained. The extending region can be formed with high precision by patterning the conductive film.

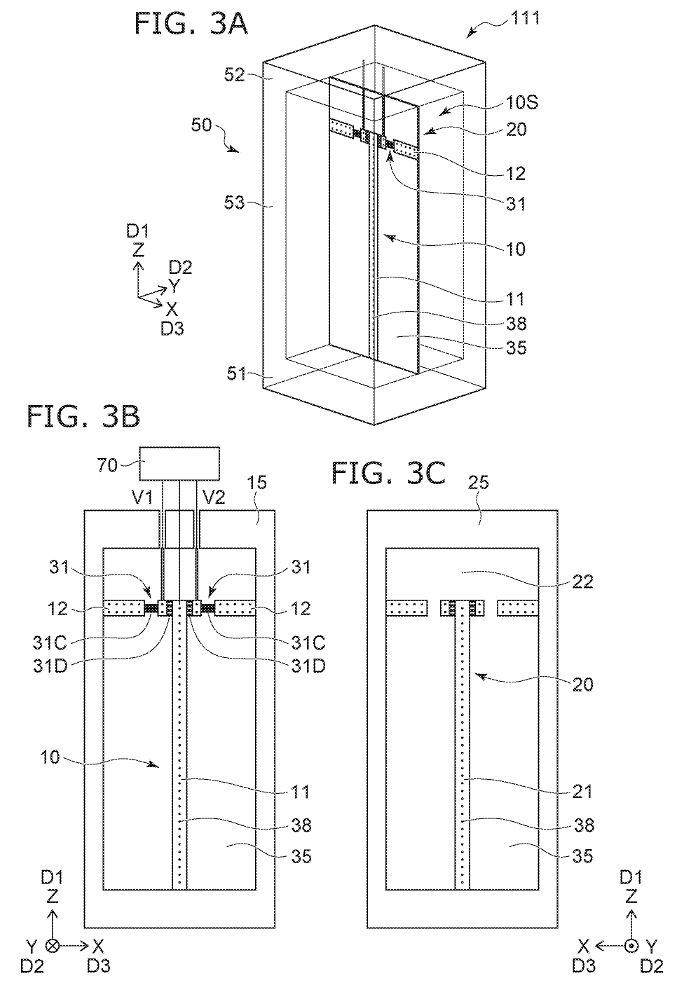

FIGS. 3A to 3C are schematic views illustrating a resonator according to the first embodiment.

FIGS. 3A is a see-through perspective view. FIGS. 3B and 3C are plan views.

As shown in FIG. 3A, in a resonator 111 according to the embodiment, the structure of the capacitive member 31 is different from the structure in the resonator 110. The configuration of the resonator 111 except for this may be the same as the configuration of the resonator 110.

As shown in FIG. 3B, in the resonator 111, the capacitive member 31 includes a variable capacitance diode 31D. In this example, the capacitive member 31 includes a plurality of variable capacitance diodes 31D. The plurality of variable capacitance diodes 31D are connected in parallel between the first extending region 11 and the first opposing region 12. A large change in capacitance can be obtained by the plurality of variable capacitance diodes 31D. The number of the plurality of variable capacitance diodes 31D is arbitrary.

In this example, the first conductive film 10 includes a plurality of first opposing regions 12. The plurality of variable capacitance diodes 31D are connected in parallel between one of the plurality of first opposing regions 12 and the first extending region 11. Another plurality of variable capacitance diodes 31D are connected in parallel between another one of the plurality of first opposing regions 12 and the first extending region 11.

The plurality of first opposing regions 12 are each connected to the first other region 15.

In this example, the capacitive member 31 further includes a capacitor 31C in addition to the variable capacitance diode 31D. The capacitor 31C is connected in series with the variable capacitance diode 31D. In this example, the variable capacitance diode 31D is connected between the first extending region 11 and the first opposing region 12. The capacitor 31C is connected between the variable capacitance diode 31D and the first opposing region 12.

The resonator 111 may further include a bias circuit 70. The bias circuit 70 is configured to control the potential of the connection point between the variable capacitance diode 31D and the capacitor 31C. In this example, there are two connection points corresponding to the two first opposing regions 12. The bias circuit 70 controls the respective potentials of the two connection points (for example, the first potential V1 and the second potential V2). The capacitance of the variable capacitance diode 31D can be controlled. The resonant frequency can be changed.

### Second Embodiment

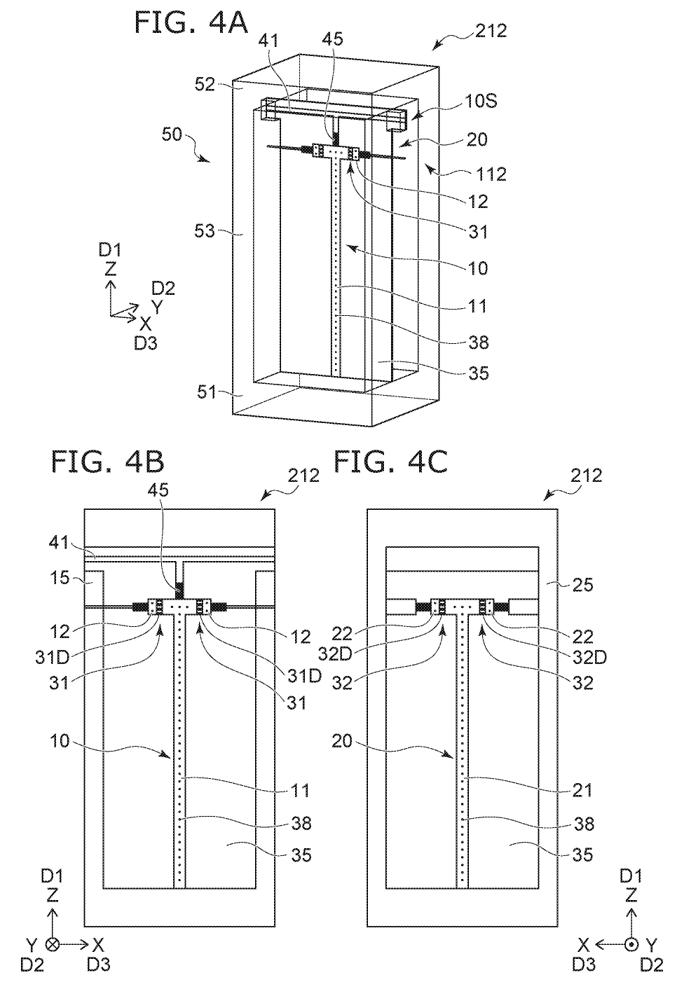

FIGS. 4A to 4C are schematic views illustrating a filter circuit according to a second embodiment.

FIG. 4A is a see-through perspective view. FIGS. 4B and 4C are plan views.

As shown in FIG. 4A, a filter circuit 212 according to the embodiment includes a resonator 112 according to the embodiment and a transmission line 41. The transmission line 41 is configured to be coupled with the first extending region 11 included in the resonator 112.

In the example of the resonator 112, the first conductive film 10 includes the plurality of first opposing regions 12. The plurality of variable capacitance diodes 31D are connected in parallel between one of the plurality of first opposing regions 12 and the first extending region 11. Another plurality of variable capacitance diodes 31D are connected in parallel between another one of the plurality of first opposing regions 12 and the first extending region 11.

In this example, the transmission line 41 contacts the dielectric substrate 35. The transmission line 41 is formed on a face of the dielectric substrate 35. The transmission line 41 may be formed from a material that becomes the first conductive film 10.

The filter circuit 212 may include a coupling member 45. The coupling member 45 is between the transmission line 41 and the resonator 112. The coupling member 45 is between the transmission line 41 and the first extending region 11 included in the resonator 112.

The coupling member 45 may include at least one of a coupling capacitor or a coupling variable capacitance diode. The coupling member 45 may include at least one selected from the group consisting of a capacitor, a variable capacitance diode, a MEMS capacitor, and a variable capacitor. The coupling member 45 may include an electromagnetic coupling structure including a plurality of electrodes. The transmission line 41 may be configured to be electromagnetically coupled with the first extending region 11.

In the filter circuit 212, for example, a signal propagating through the transmission line 41 is controlled. The filter circuit 212 functions as, for example, a band-stop filter.

The transmission line 41 may have, for example, a microstrip line structure. The transmission line 41 may have, for example, a coplanar line structure, a strip line structure, a waveguide structure, or a coaxial line structure.

By the resonator 112 coupled with the transmission line 41, a signal being input from the input terminal of the transmission line 41 is reflected at the resonant frequency of the resonator 112 and returns to the input terminal side. As a result, the signal is not output to the output side. Thereby, a specific frequency is attenuated.

For example, plurality of resonators 112 may be coupled with one transmission line 41. This makes it possible to increase the amount of attenuation, for example.

For example, the resonator 112 may include the variable capacitance diode 31D. The resonator 112 functions as a frequency-variable resonator. This makes it possible to change the stop band of the band-stop filter.

In the filter circuit 212, the coupling member 45 may include a variable capacitance diode. The stop bandwidth of the band-stop filter can be changed. For example, in a case where the amount of coupling is large, the stop band can be widened. in a case where the amount of coupling is small, the stop band can be narrowed.

For example, a variable frequency resonator and a variable coupling member may be combined. The resonant frequency and bandwidth can be changed. By a single resonator 112, it is possible to accommodate a variety of signals. For example, by increasing the characteristic impedance Zc1 based on the first extending region 11 and the metal housing 50, a large frequency variable width can be obtained while maintaining a small size.

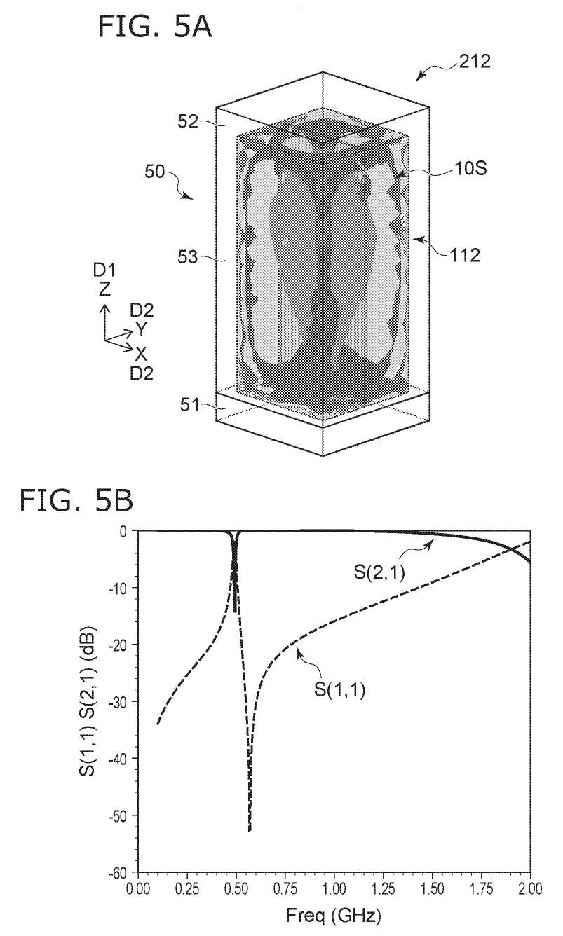

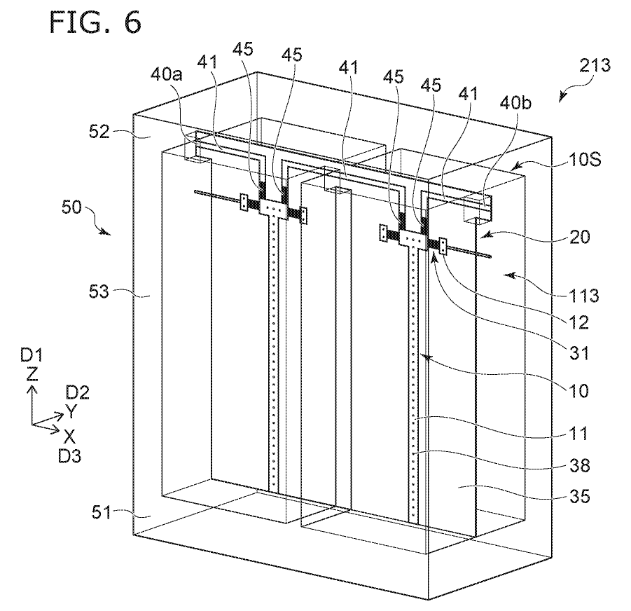

FIGS. 5A and 5B are schematic diagrams illustrating the characteristics of the filter circuit according to the second embodiment.

FIG. 5A shows a schematic diagram of the calculation results of the electric field distribution at the resonant frequency in the filter circuit 212. The density of the image in FIG. 5A corresponds to the electric field intensity. The horizontal axis of FIG. 5B is the frequency. The vertical axis is the reflection characteristic S(1,1) or the transmission characteristic S(2,1).

As shown in FIG. 5A, at the resonant frequency, the electric field is concentrated in the portion corresponding to the first extending region 11. A quarter-wave resonance is obtained.

As shown in FIG. 5B, the signal is attenuated at the resonant frequency and passes through at other frequencies. A band-stop filter with good characteristics is obtained.

### Third Embodiment

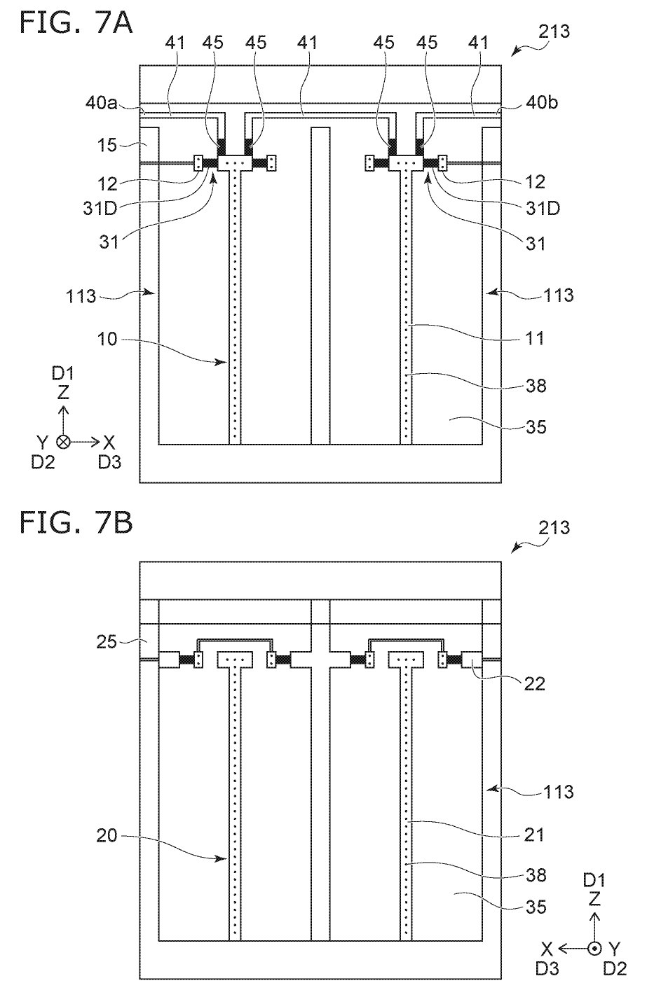

FIGS. 6, 7A and 7B are schematic views illustrating a filter circuit according to a third embodiment.

FIG. 6 is a see-through perspective view. FIG. 7A and FIG. 7B are plan views.

As shown in FIG. 6, a filter circuit 213 according to the embodiment includes a plurality of resonators 113 according to the embodiment and a plurality of transmission lines 41.

In one of the plurality of resonators 113, the first conductive film 10 includes a plurality of first opposing regions 12. In this example, a variable capacitance diode 31D is connected between one of the plurality of first opposing regions 12 and the first extending region 11. A variable capacitance diode 31D is connected between another one of the plurality of first opposing regions 12 and the first extending region 11.

In this example, the plurality of transmission lines 41 are in contact with the dielectric substrate 35. The plurality of transmission lines 41 are formed on a face of the dielectric substrate 35. The plurality of transmission lines 41 may be formed from a material that will become the first conductive film 10.

One of the plurality of transmission lines 41 is configured to be coupled with the input/output section (input section 40a or output section 40b) and one of the plurality of resonators 113. Another one of the plurality of transmission lines 41 is configured to be coupled with one of the plurality of resonators 113 and another one of the plurality of resonators 113. The filter circuit 213 functions, for example, as a band-pass filter.

The filter circuit 213 may include the coupling member 45. The coupling member 45 is between one of the plurality of transmission lines 41 and one of the plurality of resonators 113. The coupling member 45 may include at least one of a coupling capacitor or a coupling variable capacitance diode.

The filter circuit 213 may include the plurality of coupling members 45. One of the plurality of coupling members 45 is between another one of the plurality of transmission lines 41 and one of the plurality of resonators 113. One of the plurality of coupling members 45 may include at least one of a coupling capacitor or a coupling variable capacitance diode.

The coupling member 45 may be connected to an open end of one of the plurality of resonators 113. The coupling member 45 may be connected to an open end of the first extending region 11 included in one of the plurality of resonators 113.

The coupling member 45 included in the filter circuit 213 may include at least one selected from the group consisting of a capacitor, a variable capacitance diode, a MEMS capacitor, and a variable capacitor. The coupling member 45 may include an electromagnetic coupling structure including plurality of electrodes. One of the plurality of transmission lines 41 and one of the plurality of resonators 113 may be coupled by electromagnetic field coupling.

A low-loss bandpass filter is obtained by the filter circuit 213.

### Fourth Embodiment

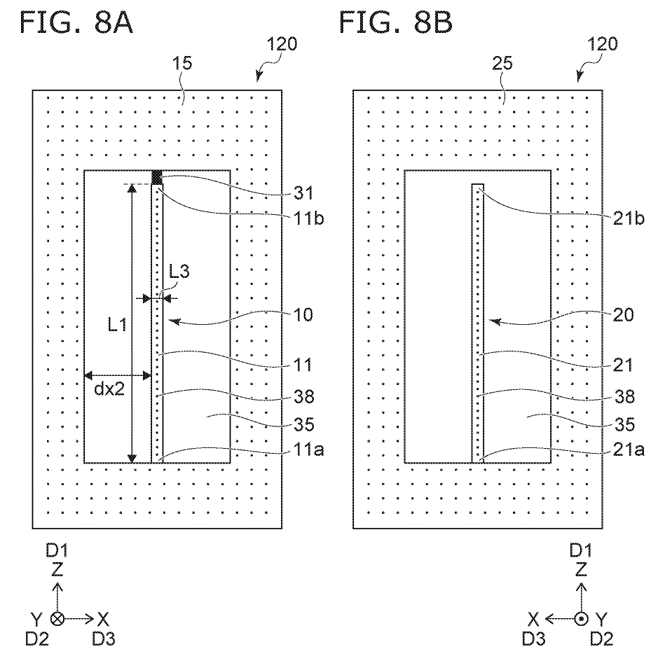

FIGS. 8A and 8B are schematic plan views illustrating a resonator according to a fourth embodiment.

As shown in FIGS. 8A and 8B, a resonator 120 according to the embodiment includes the first conductive film 10, the second conductive film 20, the dielectric substrate 35, the connecting member 38, and the capacitive member 31.

The first conductive film 10 includes the first extending region 11 extending along the first direction D1, and the first other region 15. The first extending region 11 includes the first portion 11a and the first other portion 11b. The direction from the first portion 11a to the first other portion 11b is along the first direction D1. The first portion 11a is connected to the first other region 15. The first other region 15 is located around the first extending region 11 in a first plane (e.g., the Z-X plane) along the first direction D1.

The second conductive film 20 includes the second extending region 21 extending along the first direction D1, and the second other region 25. The second extending region 21 includes a second portion 21a and a second other portion 21b. The direction from the second portion 21a to the second other portion 21b is along the first direction D1. The second portion 21a is connected to the second other region 25. The second other region 25 is located around the second extending region 21 in the first plane (Z-X plane). The second other portion 21b is separated from the second other region 25. The second direction D2 from the first conductive film 10 to the second conductive film 20 crosses the first plane (Z-X plane).

The dielectric substrate 35 is located between the first conductive film 10 and the second conductive film 20. The connecting member 38 pierces the dielectric substrate 35 and electrically connects the first conductive film 10 and the second conductive film 20 to each other. The capacitive member 31 is located between the first other portion 11b and the first other region 15.

In the resonator 120, the first extending region 11 being thin can be stably obtained. In the embodiment, for example, a high Q value can be stably obtained. A resonator capable of improving characteristics is provided. In the resonator 120, the capacitance of the capacitive member 31 can be variable. The resonance frequency can be controlled by changing the capacitance of the capacitive member 31. In the embodiment, a high Q value can be obtained even at a variable frequency in a wide range. For example, loss can be suppressed.

As shown in FIG. 8B, a length of the first extending region 11 along the first direction D1 is defined as a first length L1. A length of the first extending region 11 along the third direction D3 is defined as a third length L3. The third direction D3 crosses a plane including the first direction D1 and the second direction D2. The first length L1 is five times or more the third length L3. A high characteristic impedance Zc1 is easily obtained.

As shown in FIG. 8B, a distance in the third direction D3 between the first extending region 11 and the first other region 15 is defined as a second distance dx2. The first length L1 may be 1.5 times or more the second distance dx2. A high characteristic impedance Zc1 is easily obtained.

The configuration according to relation to the first embodiment can be applied to the capacitive member 31 included in the resonator 120.

Below, examples of the characteristics of the resonator will be described.

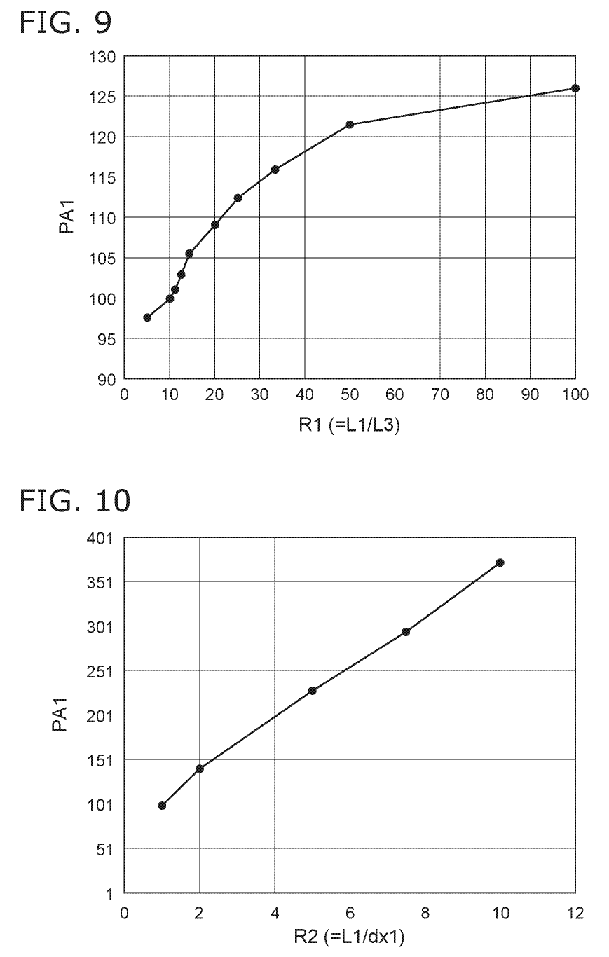

FIG. 9 is a graph illustrating the characteristics of the resonator.

The horizontal axis of FIG. 9 is a first length ratio R1. The first length ratio R1 is a ratio (L1/L3) of the first length L1 to the third length L3. The vertical axis is a characteristic evaluation parameter PA1. The characteristic evaluation parameter PA1 is a function of the frequency variation amount and the Q value. For example, under conditions where the Q value is constant, a large characteristic evaluation parameter PA1 corresponds to a large frequency variation amount. For example, under conditions where the frequency variation amount is constant, a large characteristic evaluation parameter PA1 corresponds to a high Q value (small loss). In practice, it is preferable that the characteristic evaluation parameter PA1 is large.

As shown in FIG. 9, when the first length ratio R1 (L1/L3) is high, a large characteristic evaluation parameter PA1 is obtained. It is preferable that the first length ratio R1 is high. It is preferable that the first length ratio R1 is 5 or more. The first length ratio R1 may be 10 or more. The first length ratio R1 may be 50 or more.

FIG. 10 is a graph illustrating the characteristics of the resonator.

The horizontal axis of FIG. 10 is a second length ratio R2. The second length ratio R2 is a ratio (L1/dx1) of the first length L1 to the first distance dx1. The vertical axis is the characteristic evaluation parameter PA1. As shown in FIG. 9, when the second length ratio R2 (L1/dx1) is high, a large characteristic evaluation parameter PA1 is obtained. It is preferable that the second length ratio R2 is high. It is preferable that the second length ratio R2 is 1.5 or more. The second length ratio R2 may be 5 or more.

In the first to fourth embodiments, another conductive film may be provided between the first conductive film 10 and the second conductive film 20. Another dielectric substrate may be provided between the first conductive film 10 and another conductive film. For example, the first conductive film 10 may be provided on a face of one dielectric substrate. Another conductive film may be provided on another face (e.g., the back face) of the dielectric substrate. The second conductive film 20 may be provided on a face of the other dielectric substrate. Another conductive film may be provided on another face (e.g., the back face) of the other dielectric substrate. The two back faces may face each other. In this way, a multi-layered stacked structure may be applied. In the stacked structure, the number of dielectric substrates to be stacked is arbitrary.

The embodiments may include the following Technical proposals:

### Technical proposal 1

A resonator, comprising:

a structure; and

a metal housing,

the structure including:

a first conductive film including a first extending region extending along a first direction and a first opposing region;

a second conductive film, a second direction from the first conductive film to the second conductive film crossing the first direction;

a dielectric substrate between the first conductive film and the second conductive film;

a connecting member piercing the dielectric substrate and electrically connecting the first conductive film and the second conductive film; and

a capacitive member between the first extending region and the first opposing region,

the metal housing including a first metal portion, a second metal portion, and a side portion,

the structure being between the first metal portion and the second metal portion in the first direction, and

the side portion being around the structure in a plane crossing the first direction.

### Technical proposal 2

The resonator according to Technical proposal 1, wherein

a first length of the first extending region along the first direction is 5 times or more a third length of the first extending region along a third direction, and

the third direction crosses a plane including the first direction and the second direction.

### Technical proposal 3

The resonator according to Technical proposal 1 or 2, wherein

the capacitive member includes a variable capacitance diode.

### Technical proposal 4

The resonator according to Technical proposal 1 or 2, wherein

the capacitive member includes a plurality of variable capacitance diodes,

the plurality of variable capacitance diodes are connected in parallel between the first extending region and the first opposing region,

### Technical proposal 5

The resonator according to Technical proposal 1 or 2, wherein

the capacitive member includes a variable capacitance diode and a capacitor connected in series with the variable capacitance diode.

### Technical proposal 6

The resonator according to Technical proposal 5, further comprising:

a bias circuit configured to control a potential at a connection point between the variable capacitance diode and the capacitor.

### Technical proposal 7

The resonator according to any one of Technical proposals 1-6, wherein

the first conductive film further includes a first other region,

the first other region is located around the first extending region in a first plane crossing the second direction, and

the first opposing region is connected to the first other region.

### Technical proposal 8

The resonator according to Technical proposal 7, wherein

the second conductive film includes a second extending region extending along the first direction, and a second other region,

a direction from the first extending region to the second extending region is along the second direction, and

the second other region is located around the second extending region in the first plane.

### Technical proposal 9

The resonator according to any one of Technical proposals 1-8, wherein

a characteristic impedance of a coaxial circuit including the first conductive film, the second conductive film, and the metal housing is 100 Ω or more.

### Technical proposal 10

The resonator according to Technical proposal 1, wherein

a first length of the first extending region along the first direction is 1.5 times or more a distance between the first extending region and the side portion.

### Technical proposal 11

A resonator, comprising:

a first conductive film including a first extending region extending along a first direction, and a first other region, the first extending region including a first portion and a first other portion, a direction from the first portion to the first other portion being along a first direction, the first portion being connected to the first other region, and the first other region being around the first extending region in a first plane along the first direction;

a second conductive film including a second extending region extending along the first direction, and a second other region, the second extending region including a second portion and a second other portion, a direction from the second portion to the second conductive film being along the first direction, the second portion being connected to the second other region, the second other region being around the second extending region on the first plane, the second other portion being spaced from the second other region, and a second direction from the first conductive film to the second conductive film crossing the first plane;

a dielectric substrate between the first conductive film and the second conductive film;

a connecting member piercing the dielectric substrate and electrically connecting the first conductive film and the second conductive film to each other; and

a capacitive member between the first other portion and the first other region.

### Technical proposal 12

A filter circuit, comprising:

the resonator according to any one of Technical proposals 1-10; and

a transmission line configured to be coupled with the first extending region.

### Technical proposal 13

The filter circuit according to Technical proposal 12, wherein

the transmission line contacts the dielectric substrate.

### Technical proposal 14

The filter circuit according to Technical proposal 12 or 13, further comprising:

a coupling member between the transmission line and the resonator,

the coupling member including at least one of a coupling capacitor or a coupling variable capacitance diode.

### Technical proposal 15

The filter circuit according to Technical proposal 12, wherein

the transmission line is configured to be electromagnetically coupled with the first extending region.

### Technical proposal 16

A filter circuit, comprising:

a plurality of the resonators according to any one of Technical proposals 1-10;

a plurality of transmission lines; and

an input/output section,

one of the plurality of transmission lines being configured to be coupled with the input/output section and one of the plurality of resonators, and

another one of the plurality of transmission lines being configured to be coupled with the one of the plurality of resonators and another one of the plurality of resonators.

### Technical proposal 17

The filter circuit according to Technical proposal 16, further comprising:

a coupling member between the one of the plurality of transmission lines and the one of the plurality of resonators,

the coupling member including at least one of a coupling capacitor or a coupling variable capacitance diode.

### Technical proposal 18

The filter circuit according to Technical proposal 16, further comprising:

a coupling member between the other one of the plurality of transmission lines and the one of the plurality of resonators,

the coupling member includes at least one of a coupling capacitor or a coupling variable capacitance diode.

### Technical proposal 19

The filter circuit according to Technical proposal 17, wherein

the coupling member is connected to an open end of the one of the plurality of resonators.

### Technical proposal 20

The filter circuit according to Technical proposal 16, wherein

the one of the plurality of transmission lines and the one of the plurality of resonators are coupled by electromagnetic coupling.

According to the embodiment, a resonator and a filter circuit are provided that can improve characteristics.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the resonator or the filter circuits such as conductive films, dielectric substrates, capacitive members, controller, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all resonators and all filter circuits practicable by an appropriate design modification by one skilled in the art based on the resonator and the filter circuits described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A resonator, comprising:
a structure; and
a metal housing,
the structure including:
a first conductive film including a first extending region extending along a first direction and a first opposing region;
a second conductive film, a second direction from the first conductive film to the second conductive film crossing the first direction;
a dielectric substrate between the first conductive film and the second conductive film;
a connecting member piercing the dielectric substrate and electrically connecting the first conductive film and the second conductive film; and
a capacitive member between the first extending region and the first opposing region,
the metal housing including a first metal portion, a second metal portion, and a side portion,
the structure being between the first metal portion and the second metal portion in the first direction, and
the side portion being around the structure in a plane crossing the first direction.

2. The resonator according to claim 1, wherein
a first length of the first extending region along the first direction is 5 times or more a third length of the first extending region along a third direction, and
the third direction crosses a plane including the first direction and the second direction.

3. The resonator according to claim 1, wherein
the capacitive member includes a variable capacitance diode.

4. The resonator according to claim 1, wherein
the capacitive member includes a plurality of variable capacitance diodes,
the plurality of variable capacitance diodes are connected in parallel between the first extending region and the first opposing region.

5. The resonator according to claim 1, wherein
the capacitive member includes a variable capacitance diode and a capacitor connected in series with the variable capacitance diode.

6. The resonator according to claim 5, further comprising:
a bias circuit configured to control a potential at a connection point between the variable capacitance diode and the capacitor.

7. The resonator according to claim 1, wherein
the first conductive film further includes a first other region,
the first other region is located around the first extending region in a first plane crossing the second direction, and
the first opposing region is connected to the first other region.

8. The resonator according to claim 7, wherein
the second conductive film includes a second extending region extending along the first direction, and a second other region,
a direction from the first extending region to the second extending region is along the second direction, and
the second other region is located around the second extending region in the first plane.

9. The resonator according to claim 1, wherein
a characteristic impedance of a coaxial circuit including the first conductive film, the second conductive film, and the metal housing is 100 Ω or more.

10. The resonator according to claim 1, wherein
a first length of the first extending region along the first direction is 1.5 times or more a distance between the first extending region and the side portion.

11. A resonator, comprising:
a first conductive film including a first extending region extending along a first direction, and a first other region, the first extending region including a first portion and a first other portion, a direction from the first portion to the first other portion being along a first direction, the first portion being connected to the first other region, and the first other region being around the first extending region in a first plane along the first direction;
a second conductive film including a second extending region extending along the first direction, and a second other region, the second extending region including a second portion and a second other portion, a direction from the second portion to the second conductive film being along the first direction, the second portion being connected to the second other region, the second other region being around the second extending region on the first plane, the second other portion being spaced from the second other region, and a second direction from the first conductive film to the second conductive film crossing the first plane;
a dielectric substrate between the first conductive film and the second conductive film;
a connecting member piercing the dielectric substrate and electrically connecting the first conductive film and the second conductive film to each other; and
a capacitive member between the first other portion and the first other region.

12. A filter circuit, comprising:
the resonator according to claim 1; and
a transmission line configured to be coupled with the first extending region.

13. The filter circuit according to claim 12, wherein
the transmission line contacts the dielectric substrate.

14. The filter circuit according to claim 12, further comprising:
a coupling member between the transmission line and the resonator,
the coupling member including at least one of a coupling capacitor or a coupling variable capacitance diode.

15. The filter circuit according to claim 12, wherein
the transmission line is configured to be electromagnetically coupled with the first extending region.

16. A filter circuit, comprising:
a plurality of the resonators according to claim 1;
a plurality of transmission lines; and
an input/output section,
one of the plurality of transmission lines being configured to be coupled with the input/output section and one of the plurality of resonators, and
another one of the plurality of transmission lines being configured to be coupled with the one of the plurality of resonators and another one of the plurality of resonators.

17. The filter circuit according to claim 16, further comprising:
a coupling member between the one of the plurality of transmission lines and the one of the plurality of resonators,
the coupling member including at least one of a coupling capacitor or a coupling variable capacitance diode.

18. The filter circuit according to claim 16, further comprising:
a coupling member between the other one of the plurality of transmission lines and the one of the plurality of resonators,
the coupling member includes at least one of a coupling capacitor or a coupling variable capacitance diode.

19. The filter circuit according to claim 17, wherein
the coupling member is connected to an open end of the one of the plurality of resonators.

20. The filter circuit according to claim 16, wherein
the one of the plurality of transmission lines and the one of the plurality of resonators are coupled by electromagnetic coupling.
